(19) United States
(12) Patent Application Publication
(10) Pub. No.: US 2009/0302261 A1
(43) Pub. Date: Dec. 10, 2009

(54) Self-sealing bite valve

(75) Inventor: Jeffrey Skillern, Boise, ID (US)

Correspondence Address: KNOBBE MARTENS OLSON & BEAR LLP, 2040 MAIN STREET, FOURTEENTH FLOOR, IRVINE, CA, 92614, US

(73) Assignee: Polar Design, Inc., Boise, ID (US)

(21) Appl. No.: 12/322,995

(22) Filed: Feb. 9, 2009

Related U.S. Application Data
(60) Provisional application No. 61/026,961, filed on Feb. 7, 2008.

(51) Int. Cl. F16K 1/06

(52) U.S. Cl. 251/337

(57) ABSTRACT

“A liquid dispensing release mechanism that includes an internal seal there of opening and closing when user actuated to release flow and prevent leaking.”

### BACKGROUND

A conventional bite valve has a resilient sheath and a main body. The sheath has an opening on one end through which liquid passing through the main body can be expelled. The other end of the sheath is affixed to the main body. Within the sheath is a seal rod and a biasing member such as a compression spring. The biasing member supplies a force that urges the an end of the seal rod into the opening of the sheath. That end of the seal trod s shaped to fill that opening and provide a seal that helps prevent liquid from escaping through the bite valve. The seal rod is configured so that when a user bites down on the sheath, the sheath compresses into the seal rod forcing the seal rod into the main body. Sufficient bite pressure overcomes the biasing member. This causes the end of the seal rod to disengage from the sheath's opening, thus allowing liquid to pass through the main body and out the opening. US Pub. 2007/0164037 to Chen describes such a conventional bite valve.

When such a bite valve is coupled to a pressurized source, maintaining a proper seal is desirable. Through use and time, the sheath's opening can deform resulting in a poor or inoperative seal allowing undesired leaking.

### DESCRIPTION OF THE DRAWINGS

FIGS. 1 and 2 are cross-sectional views of an exemplary bite valve according to an embodiment. In FIG. 1, the bite valve is in a closed position. In FIG. 2, the bite valve is in an open position.

FIG. 3 is a photo view of a deconstructed bite valve according to an embodiment.

FIGS. 4-8 show a reconstruction of the bite valve according to an embodiment. FIG. 4 is a photo view of view showing the seal post inserted through the collar. FIG. 5 is a photo view showing the o-ring placed on the seal post. FIG. 6 is a photo view showing the biasing member coupled to the seal post. FIG. 7 is a photo view showing the seal post, collar, o-ring, and biasing member assembly inserted in the bite valve body according to an embodiment. In FIG. 7, the biasing member is urging the seal post out of the bite valve main body, thus closing the bite valve according to an embodiment. In FIG. 8, the seal post is being urged back into the body overcoming the biasing member to open the bite valve according to an embodiment.

### DETAILED DESCRIPTION

It is desirable, especially when coupled to a pressurized source, that a bite valve maintain a proper seal when closed. Otherwise liquid from the pressurized source could leak from the valve. Various embodiments of the present invention assist in maintaining a proper seal in a bite valve even when that bite valve is coupled to a pressurized source. An example of a pressurized source is described in co-pending U.S. application Ser. No. 11/764,620 entitled “Pressurized Hydration System.” Application Ser. No. 11/764,620 is hereby incorporated by reference.

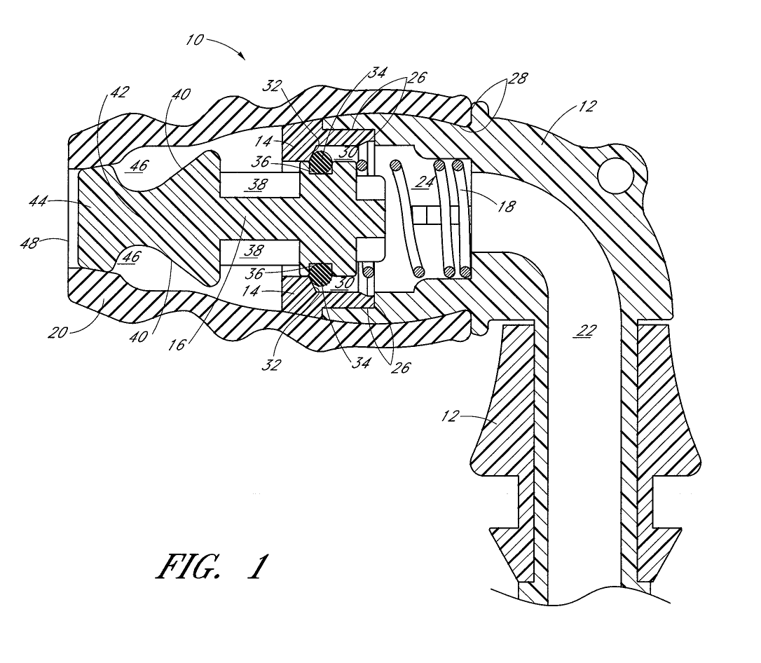

FIGS. 1-8 illustrate an exemplary bite valve 10. As shown, bite valve 10 includes body 12, collar 14, seal post 16, biasing member 18, and sheath 20. Body 12 represents generally any structure through which fluid can flow. Referring to FIG. 1, body 12 includes body flow channel 22, biasing member cavity 24, collar support 26, and sheath support 28. Body flow channel 22 is a passageway though which a fluid can pass through body 12. While not shown, body 12 can be coupled to a fluid reservoir via a drinking tube. In a manner discussed in more detail below, fluid can pass from that reservoir through that drinking tube passing through body flow channel 22.

Biasing member cavity 24 represents a portion of the interior surface of body 12 within body flow channel 22 that is configured to hold or otherwise contain and support biasing member 18. Collar support 24 represents a portion of the interior surface of body 12 to which collar 14 can be affixed, removably or otherwise. Sheath support 28 represents a portion of the exterior surface of body 12 to which sheath 20 can be affixed, removably or otherwise.

Collar 14 represents generally any structure configured to be affixed to collar support 24 of body 12 while allowing fluid to flow through body flow channel 22. Collar 14 includes collar flow channel 30 and seal lip 32. Collar flow channel 30 represents a passage through which fluid can flow through collar 14 with collar 14 affixed to body 12. Seal lip 32 represents an interior surface of collar 14 within collar flow channel 30 that is against which a sealing component such as an o-ring can be pressed to impede the flow of fluid through body flow channel 22.

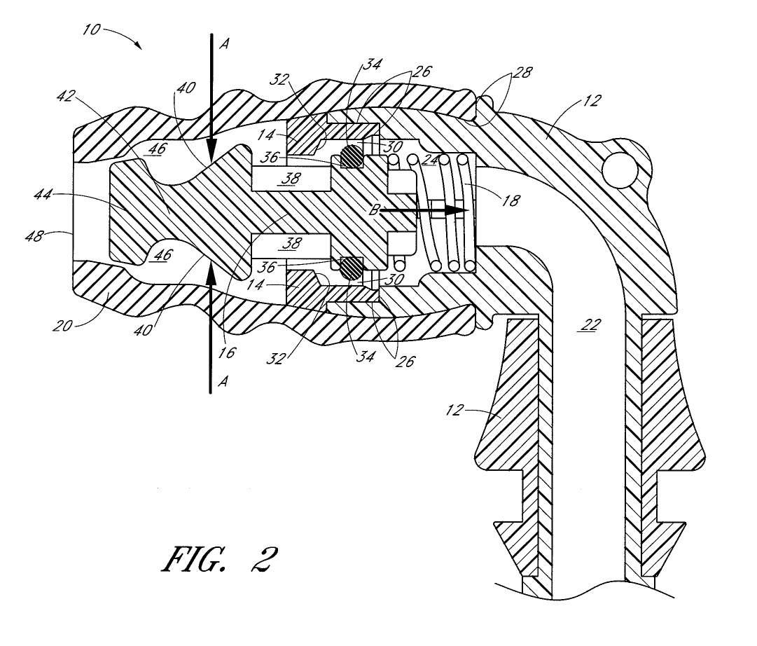

Seal post 16 represents generally any structure slideable between an extended position (FIG. 1) and an inserted position(FIG. 2) through collar flow channel 30 of collar 14. Seal post 16 includes o-ring 34, o-ring groove 36, and valve post flow channels 38. O-ring 34 represents generally any pliable material that can fit around seal post 16 increasing a diameter of seal post 16 at a given point. O-ring groove 36 defines the point at which o-ring 34 fits around seal post 16. Seal post channels 38 represent passageways formed when seal post 16 is inserted through collar 14. Fluid is allowed to flow through body flow channel 22, collar flow channel 30 and these passageways 38 when seal post is slid into the inserted position of FIG. 2. When in the extended position of FIG. 1, o-ring 34 of seal post 16 is pressed against seal lip 34 of collar 14 impeding the fluid flow. In this example, fluid is blocked from passing through collar flow channel 30 and into seal post channels 38 when seal post is extended as shown in FIG. 1. When seal post is slid to the inserted position shown in FIG. 2, fluid is allowed to pass through collar flow channel 30 and into seal post channels 38.

Biasing member 18 represents generally any structure configured to apply a biasing force on seal post 16 to keep seal post 16 in the extended position shown in FIG. 1. Biasing member 18, in this example, is a compression spring configured to fit within biasing cavity 24. One end of biasing member 18 is supported by biasing member cavity 24. The other end of biasing member 24 presses against the end of seal post 16 that is inserted through collar 14. The biasing force of biasing member 18 is overcome by sliding seal post through collar 14 and further into body 12—that is—by compressing biasing member 18 as shown in FIG. 2. When the force needed to compress biasing member 18 is removed, biasing member forces seal post to the extended position shown in FIG. 1. The compression of o-ring 34 against seal lip 32 stops seal post 16 from being extended further and closes or seals bite valve 10.

Seal post 16 is also shown to include seal post incline 40, seal post neck 42, and seal post tip 44. Seal post incline 40 represents an inclined surface of seal post 40. The incline is noticeable with respect to a longitudinal axis of seal post 16, the longitudinal axis being an axis of seal post 16 that is parallel to the direction seal post 16 slides through collar 14. Seal post neck 42 represents a portion of seal post 16 at the point where valve post incline has its smallest diameter. Valve post tip 44 extends from valve post neck 43 with a larger diameter. Valve post tip is configured to generally seal an opening in sheath 20 when seal post 16 is in the extended position of FIG. 1.

Sheath 20 represents generally any pliable material such as silicone configured to fit around seal post 16 and couple to sheath support 28 of body 12. Sheath 20 includes sheath flow channel 46 and sheath opening 48. Sheath flow channel represents a passageway through which fluid pass out of bite valve 10 through sheath opening 48. With seal post 16 forced into the inserted position of FIG. 2. Fluid can pass though bite valve 10 via body flow channel 22, collar flow channel 30, seal post flow channels 38, sheath flow channel 46 and sheath opening 48.

Referring to FIG. 2, to overcome the biasing force of biasing member 18, one bides down on sheath 20. The pressure from the bite compresses sheath 20 against valve post incline 40. The inclined surface of valve post incline 40 translates the pressure of the bite causing valve post 16 to slide into body 12 compressing biasing member 18 and opening bite valve 10. If attached to a pressurized liquid source, liquid from that source is forced through bite valve 10 and into the mouth of the person biting sheath 20. Once the person stops biting, biasing member 18 urges seal post back to the extended position closing bite valve 10. When coupled top a pressurized source, the force from the pressurization supplements the biasing force of biasing member 18 further improving the seal between o-ring 34 and seal lip 32.

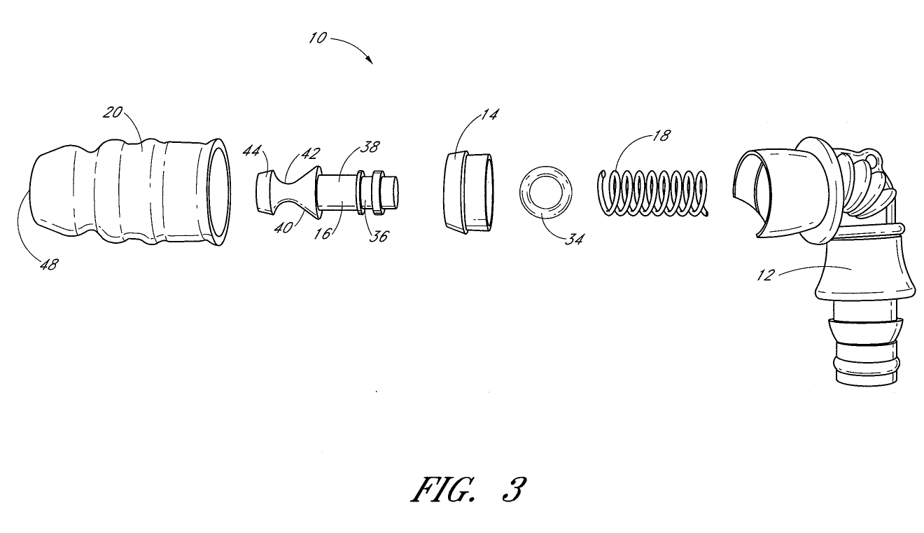

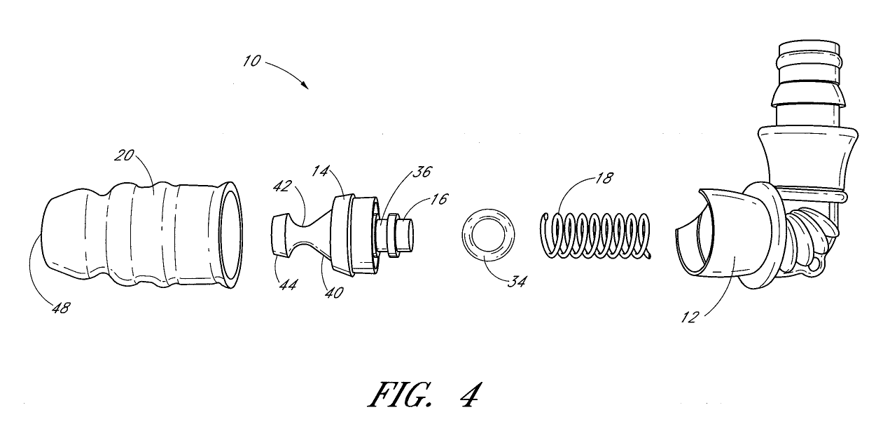

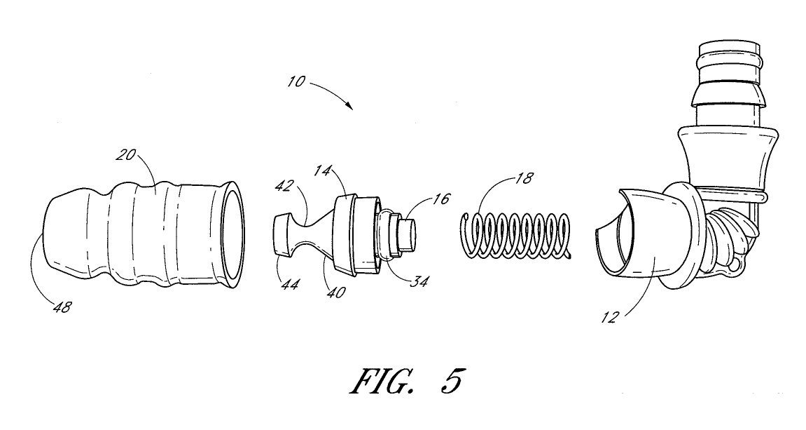

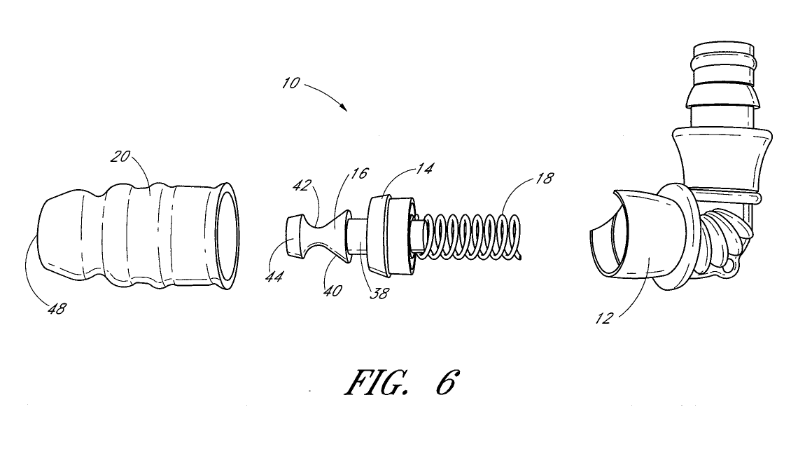

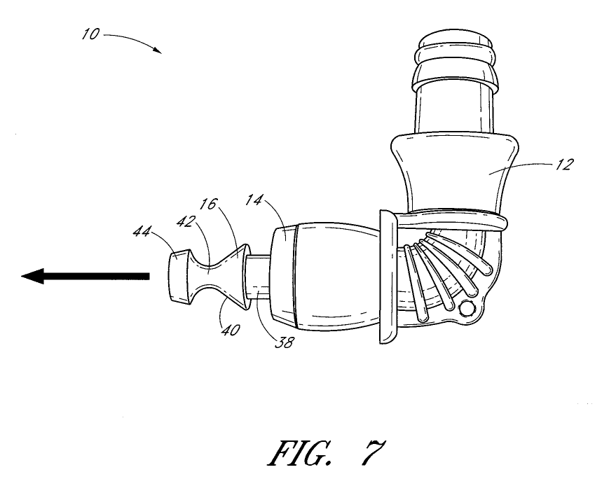

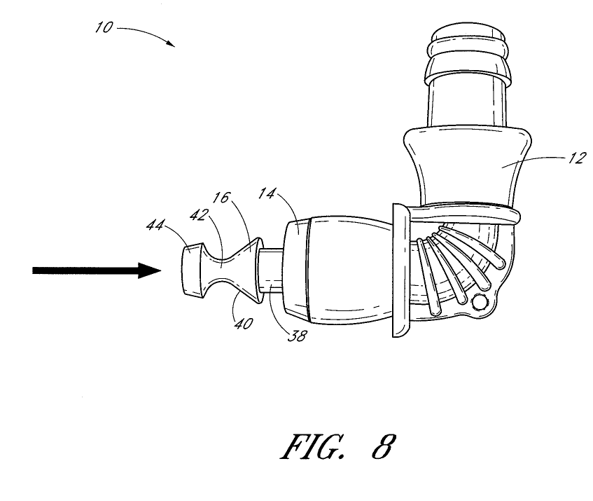

FIGS. 3-8 illustrate the assembly of bite valve 10. In FIG. 3, bite valve 10 is separated into its various components, body 12, biasing member 18, o-ring 34, collar 14, seal post 16, and sheath 20. In FIG. 4, seal post 16 has been inserted through collar 14. In FIG. 5, o-ring 34 has be placed in o-ring groove 36 (see FIGS. 1 and 2) of seal post 16. In FIG. 6, one end of biasing member 18 has been coupled to the end of seal post 16 that was inserted through collar 14. In FIG. 7, the assembly of seal post 16, collar 14, and biasing member 18 is partially inserted in and coupled to body 12. While not visible, biasing member is fit into biasing member cavity 24 of body 12 and collar 14 is affixed to collar support 26 of body 12. In FIG. 7, biasing member 18 is holding seal post 16 in the extended position closing bite valve 10. In FIG. 8, seal post is being slid into the inserted position opening bite valve 10. While not shown, sheath 20 can then be placed around seal post 16 and coupled to body 12 completing the assembly of bite valve 10

The various examples discussed above provide for a bite valve with an improved sealing capability. When coupled to a pressurized source, the force from the pressurization acts to further improve that seal.

1. A bite valve with internal on and off shut of mechanism
